(19) United States
(12) Patent Application Publication
(10) Pub. No.: US 2009/0081459 A1
(43) Pub. Date: Mar. 26, 2009

(54) ORGANIC FOAMING PLASTIC BODY HAVING EXCELLENT THERMAL RESISTANCE AND DURABILITY

(76) Inventors: Jong-Hyeon Yoon, Chungcheongnam-do (KR); Beom-Gyu Baek, Ulsan (KR); Yoon-Sik Lee, Chungcheongnam-do (KR)

Correspondence Address: CANTOR COLBURN, LLP, 20 Church Street, 22nd Floor, Hartford, CT, 06103, US

(21) Appl. No.: 12/159,948

(22) PCT Filed: Feb. 8, 2007
(86) PCT No.: PCT/KR07/00680

§ 371 Date: Jul. 2, 2008

(30) Foreign Application Priority Data
Feb. 9, 2006 (KR) 10-2006-0012481

(51) Int. Cl. B32B 15/02; C08J 9/35

(52) U.S. Cl. 428/404; 521/53

(57) ABSTRACT

Disclosed is an expanded organic foam material having excellent thermal resistance and durability. The expanded plastic foam material is produced by preparing plastic beads or plastic foams, modifying silicate with at least one selected from among an alkaline earth metal compound, an alkaline earth metal compound-containing material, and an acid, coating the modified silicate on the prepared plastic beads or plastic foams, melt-molding the coated plastic beads or plastic foams while applying heat and pressure thereto, and drying the molded material. Also, the expanded organic plastic foam material has good impact-absorbing properties, easy formability, excellent sound-insulating and sound-absorbing performance and thermal insulating performance, good flame retardancy and thermal resistance, and improved water resistance and durability.

### TECHNICAL FIELD

The present invention relates to an expanded organic plastic foam material having excellent thermal resistance and durability, and more particularly to an expanded organic plastic foam material, which has good impact-absorbing properties, easy formability and excellent sound-absorbing performance and thermal insulating performance.

Also, the present invention relates to an expanded organic plastic foam material, which maintains the non-inflammable properties of inorganic silicate and, at the same time, has markedly improved thermal resistance so as to block flames upon a fire, and shows improved durability.

### BACKGROUND ART

Expanded organic plastics have advantages of good impact absorbing properties, easy formability, and excellent sound-absorbing performance and thermal insulating performance over inorganic materials, and thus are frequently used as sound-absorbing and thermal insulating materials.

However, the expanded organic plastics have a problem in that they cannot maintain their shape, because they melt out even at relatively low temperatures due to low softening point and melting point. Furthermore, when they catch fire, they will show no resistance to fire, and when they are ignited with flames due to external ignition factors, the expanded plastics themselves will act as energy sources helping combustion to spread the flame.

Due to such problems, the use of the expanded plastics particularly as building materials has been gradually limited.

To solve these problems associated with inflammability, various studies have been conducted.

A method of imparting flame retardancy to foamed molded plastic bodies by adding a flame retardant to resin to make flame-retardant resin and expanding the flame-retardant resin has been generally known and used in the prior art.

However, the expanded plastics prepared using this method or technique remain at the level of self-extinguishing plastics, which are extinguished upon the removal of a fire source after contact with flames, and these expanded plastics do not reach the lowest grade of standards according to KS F 2271 (test method for flame retardancy of building interior materials and structures), and thus have cannot resist fire.

Recently, in order to overcome the limitation of the organic materials, deep studies on techniques of imparting flame retardancy by treating expanded plastics with an inorganic adhesive as a non-inflammable material have been conducted.

As an example, Korean Patent Application No. 10-2003-0027876, entitled “expanded plastic foam material having excellent fire resistance”, filed in the name of the applicant, discloses an expanded plastic foam material imparted with fire-resistant performance using organic and inorganic fire-resistant barrier forming materials.

This technique ensures the flame retardancy of the expanded plastic foam material, but provides insufficient thermal resistance for use as the core material of a fire resistant structure serving to block flames upon a fire.

Korean Patent Application No. 10-2003-0018763, entitled “flame-retardant polystyrene panel and manufacturing method thereof” discloses flame-retardant expanded polystyrene prepared by dissolving sodium silicate powder as non-inflammable material in water and coating the surface of expanded polystyrene with the aqueous sodium silicate solution alone or in a mixture with water glass.

The expanded polystyrene according to this technique ensures flame retardancy by applying only the non-inflammable property of the silicate-based adhesive to the expanded organic plastic, but shows the following various problems when it catches fire or is used in practice.

First, thermal resistance required in the core material of a fire-resistant structure upon a fire can be divided into two categories: thermal resistance at a relatively low temperature of about 150-400° C. when a heat source is around the material, but before the material is in actual contact with flames; and thermal resistance at high temperature, when the material is in actual contact with flames.

However, in the case of the products manufactured according to the above technique or method, expanded plastics as organic materials are degraded at a temperature of about 150-300° C.

Moreover, in the case where a fire-resistant barrier for serving as the backbone of a structure upon contact with flames consist of silicate having high water content, if the barrier is heated at a temperature above 200° C., the water content of the barrier will be volatilized to cause foam expansion in the barrier, thus forming cracks in the barrier. Accordingly, the structures will be collapsed due to many cracks, before they are in actual contact with flames.

Furthermore, even if this shortcoming is overcome so that the barrier is not completely collapsed, solid silicate starts to melt at a relatively low temperature of 550-670° C. and to flow at 730-870° C. Thus, the barrier is melted at a temperature above 700° C. at which it is in actual contact with flames, and thus the structure serving as a fireproof wall is collapsed to lose its original function of preventing the spread of flames.

Second, there is water resistance, which is an important physical property in practical use and has a great effect on durability.

Silicate used for forming the fire-resistant barrier or flame-retardant coating film in the above technique or method exists in various forms, including alkali metal ions, silicate ion monomers, polysilicate ions, and micells (colloidal particles) formed by loose binding of such silicate ions, according to SiO₂/M₂O molar ratio and concentration in the liquid phase.

Thus, because the fire-resistant barrier or flame-retardant coating film on the bead surface dewatered by drying has a high solubility of about 30-60%, it is considerably dissolved in practical use due to rainwater or long-term moisture absorption, and thus the original function thereof is difficult to show sufficiently.

Third, among important physical properties required in practical use, there are flexibility and adhesive properties. However, silicate used in the above techniques or methods has brittleness, the property of inorganic material, without change, it is difficult to expect the interfacial adhesion between expanded organic plastic having hydrophobicity and silicate having hydrophilic hydroxyl groups, and the expanded organic plastic and the silicate are merely forcedly attached to each other.

As described above, the above techniques or methods ensure some flame retardancy, but silicate structures that must serve as fire-resistant barriers when a fire breaks out are expanded and collapsed due to low melting point and flames while they fail to effectively prevent the spread of flames, and thus it is difficult to use the expanded plastic material as the core material of a fire-resistant structure that serves to block flames upon a fire.

Also, the expanded plastic materials according to the above techniques or methods have low water resistance due to high solubility, and thus show a decrease in durability due to long-term moisture absorption or rainwater.

In addition, the expanded plastic materials have a lot of problems, including brittleness as the property of inorganic silicate, and a reduction in durability resulting from weak interfacial adhesion between hydrophobic expanded plastic and hydrophilic silicate.

### DISCLOSURE

### Technical Problem

The present invention has been made in order to solve the above-described problems occurring in the prior art, and it is an object of the present invention to provide an expanded organic plastic foam material having excellent thermal resistance and durability, and particularly to provide an expanded organic plastic foam material, which has good impact absorbing properties, easy formability, and excellent sound-absorbing performance and thermal insulating performance.

Another object of the present invention is to provide an expanded organic plastic foam material, which maintains the non-inflammable property of inorganic silicate and, at the same time, has markedly improved thermal resistance so as to block flames upon a fire, and has improved durability.

### Technical Solution

To achieve the above objects, the present invention provides an expanded organic plastic foam material, which is manufactured by preparing plastic beads or plastic foams, modifying silicate with at least one selected from among an alkaline earth metal compound, an alkaline earth metal compound-containing material, and an acid, coating the modified silicate on the prepared plastic beads or plastic foams, melt-molding the coated plastic beads or plastic foams while applying heat and pressure thereto, and drying the molded material.

Moreover, during the formation of the expanded plastic according to the present invention, at least one selected from the group consisting of alcohol, ether, ketone and ester compounds may also be added in order to modify silicate.

The inventive expanded plastic foam material formed to have a fire-resistant barrier can be used as the core material of a fire-resistant structure, because the fire-resistant barriers block flames upon a fire. Also, it can be advantageously used in practice due to excellent water resistance, flexibility and adhesion properties.

In addition, the expanded plastic foam material according to the present invention shows markedly improved sound-absorbing performance due to such a barrier, has a modified surface, and thus has improved interfacial adhesion to other materials. Accordingly, it can be used in various applications, including bonding with sheet materials, coating with spray coating materials.

The expanded organic plastics used in the present invention include expanded polystyrene, expanded polyethylene, expanded polypropylene, expanded polyurethane, phenol foam, and the like.

Also, silicate used in the present invention is a compound represented by M₂O.nSiO₂.xH₂O, wherein M represents an alkali metal belonging to Group 1A of the periodic table, and n and x each represents an integer.

Specific examples of the alkali metal belonging to Group 1A include lithium, sodium and potassium.

The alkaline earth metal compound used in the present invention is represented by MmXn, wherein M is an alkaline earth metal belonging to Group 2A of the periodic table, X is selected from among Cl, OH, SO₄ and O, and each of m and n is an integer.

Specific examples of the alkaline earth metal belonging Group 2A include beryllium (Be), magnesium (Mg), calcium (Ca) and barium (Ba).

The alkaline earth metal compound-containing materials used in the present invention include cement, blast furnace cement, magnesia cement, gypsum, lime, and blast furnace slag.

The principle according to which the expanded plastic foam material of the present invention has improved thermal resistance, water resistance, flexibility and adhesion properties will now be described.

Silicate is allowed to react with at least one selected from acids, alkaline earth metal compounds, alkaline earth metal compound-containing materials, and modifiers such as alcohol, ether, ketone or ester compounds.

In this reaction, a silicate polymer, which is difficult to dissolve in water, or a water-insoluble salt, is produced, and silicate ions or polysilicate ions are subjected to polycondensation therebetween to remove water (H₂O) causing foam expansion resulting in a decrease in low-temperature thermal resistance and to isolate alkali metals causing a decrease in melting point, thus producing a separate salt or substituting the alkali metal with alkaline earth metals.

The expected chemical reaction mechanism between silicate and acids or the alkaline earth metal compound is as follows:

M₂O.SiO₂+H₂CO₃+H₂O→Si(OH)₄+M₂CO₃

When an acid (carbonic acid) that releases hydrogen cations is added to silicate, a metal salt is produced by neutralization while the pH of the reaction solution is decreased.

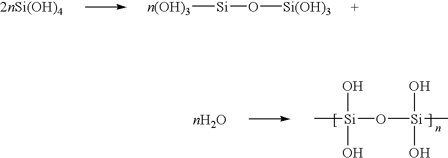

wherein n is an integer.

Silicate ions or polysilicate ions form siloxane bonds therebetween to produce oligomers in the form of hydrosol, while the viscosity of the reaction solution is gradually increased.

As the reaction further progresses, oligomers are polymerized to produce a silicate polymer in the form of gel.

Herein, the increase in viscosity and gelling rate vary depending on the kind of acid, the amount of acid added, the concentration of the solution, temperature, etc.

M₂O.nSiO₂+Ca(OH)₂+mH₂O→CaO.nSiO₂.mH₂O+2M₂OH

wherein each of m and n is an integer.

Silicate reacts with alkaline earth metal compounds belonging to Group 2A, including Be, Mg, Ca and Ba, to produce insoluble silicate metal hydrate, silicate metal hydroxide, silicic acid, etc., at the same time, and the reaction solution is gradually gelled to form a polymer having a network structure.

The silicate compound produced according to this reaction depends on the amounts of metal ions and silicate ions used.

Meanwhile, with respect to the increase in the interfacial adhesion between the expanded organic plastic and the silicate forming the fire-resistant barrier, the hydrophilic or water-soluble, polar terminal hydroxyl groups of silicate oligomers is allowed to react with an alcohol, ether, ketone or ester compound, so that they are partially substituted with hydrophobic or lipophilic, non-polar terminal alkoxy or alkyl groups. Thus, the hydrophilic polar terminal groups are collected outside the outside region due to affinity for water molecules, and the hydrophobic non-polar terminal groups having repulsive power against water molecules are collected toward the expanded organic plastic. For this reason, the adhesion between the expanded organic plastic having hydrophobic properties and the alkoxy or alkyl groups is naturally increased.

Also, the silicate oligomers are partially substituted with the hydrophobic or lipophilic non-polar terminal groups to reduce the surface tension of water, thus reducing the variation in interfacial energy between the expanded organic plastic and the silicate forming the fire-resistant barrier. This leads to an increase in dispersibility, making it possible to obtain a uniform and constant barrier thickness.

The expected chemical reaction mechanisms between the silicate oligomer and the alcohol, ether, ketone or ester compound are as follows:

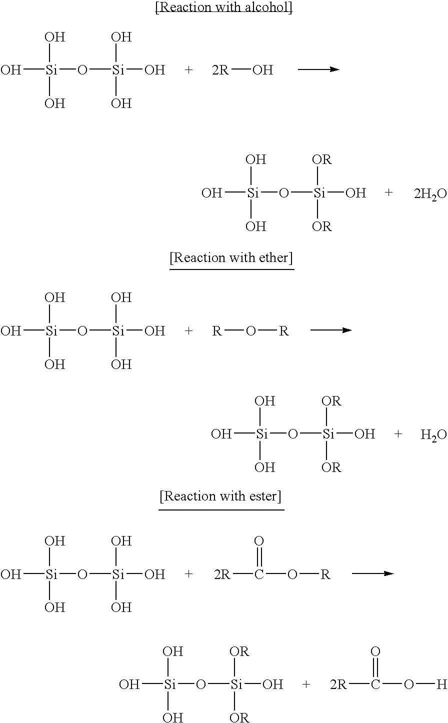

The hydrophilic hydroxyl groups of the silicate oligomer, which have high affinity for water, are detached while they are substituted with the hydrophobic alkoxy or alkyl groups of the alcohol, ether or ester compound, which have affinity for organic materials.

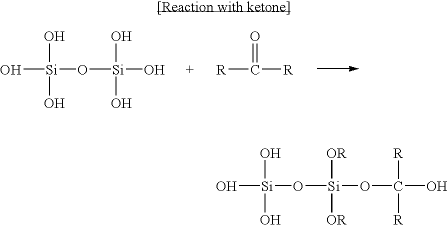

The silicate oligomer is subjected to addition polymerization with ketone having double bonds, thus forming an organosilicate compound having siloxane bonds.

As can be seen in the above chemical reactions between the silicate oligomer and the alcohol, ether, ketone or ester compound, the organosilicate compound having attached thereto two kinds of terminal groups having contrary properties, including hydrophilic hydroxyl groups and hydrophobic alkyl or alkoxy groups, is produced to increase the stability of micells in the liquid phase and increase the interfacial adhesion between the expanded organic plastic having hydrophobic properties and the silicate. Also, the organosilicate compound reduces the surface tension of water to reduce the variation in interfacial energy between the expanded organic plastic and the silicate, and thus it has improved dispersibility and, at the same time, can be coated in a uniform and constant barrier thickness. In addition, according to the carbon atom number of the organic terminal groups, the inherent brittleness of fire-resistant barriers can be partially reduced.

Because the above-described reactions show different reaction rates depending on the kind of material used for modification, a delaying agent can be used to control reaction rate.

Herein, examples of the delaying agent include oxycarbon, fluorosilicate, borate, gluconic acid, saccharide, and citric acid.

To more effective accomplish the objects of the present invention, various additives, including an adhesive aid, a thermal resistance improver and a water repellant, may additionally be used.

Specifically, as the adhesive aid for more effectively enhancing the adhesion between the expanded organic plastic and the silicate forming the fire-resistant barrier, it is possible to add a surfactant, a silane coupling agent, PVA (polyvinyl alcohol), EVA (ethylene vinyl acetate copolymers), a cellulose adhesive, organic filler carbon black having a particle size of 10-1000 nm, graphite, montmorillonite which form nanosize colloidal particles when it is swollen by water molecules to break the structural layer thereof, bentonite, fine illite particles, or clay.

As the thermal resistance improver, it is possible to use one selected from among inorganic fillers, including antimony compounds, aluminum oxide, aluminum hydroxide, borax, phosphate, phosphorus-based flame retardants, halogen-based flame retardants, thermosetting resin, dolomite, calcium carbonate, silica powder, titanium oxide, iron oxide, ettringite compounds, perlite, and fly ash.

The above-described thermal resistance improver serves to impart flame retardancy to the expanded organic plastic, or form a large amount of char during carbonization and enhance the strength of char, thus preventing the shape of the expanded organic plastic being deformed due to heat.

In addition, as the water repellant, it is possible to use one selected from among silicon-based water repellents, fluorine-based water repellants, and paraffin-based water repellents.

The above-described water repellent makes large water contact angle when it is in contact with water, to prevent water from penetrating into the expanded plastic foam material, thus increasing water resistance.

### Advantageous Effects

As described above, the present invention provides the expanded organic plastic foam material, which has good impact-absorbing properties, easy formability, and excellent sound-absorbing performance and thermal insulating performance.

Also, the present invention provides the expanded organic plastic foam material, which maintains the non-inflammable properties of inorganic silicate and, at the same time, has markedly improved thermal resistance so as to block flames upon a fire, and has improved durability.

### BEST MODE

### Example

### Manufacturing of Expanded Plastic Foam Material

Expanded polystyrene beads (CL 2500F; SH Chemical Co., Ltd, Korea) were first expanded by adding water vapor thereto, and water was evaporated from the surface of the expanded beads. Then, the expanded beads were aged for 4 hours, such that foaming gas contained in the particles was substituted with air, and thus the particles were provided with restoring force. Then, the expanded beads were further expanded by adding water vapor thereto, thus preparing expanded beads.

50 Be′ sodium silicate was treated with 10 wt %, based on the weight of the sodium silicate, of magnesium hydroxide as an alkaline earth metal compound, and then 10 wt % of bentonite, 3 wt % of carbon black, 3 wt % of swollen perlite and 0.1 wt % of a silicon-based water repellant were added thereto. The mixture was sufficiently stirred, and then applied uniformly on the surface of the above-prepared expanded beads.

The applied expanded beads were charged into a mold having a size of 220 mm×220 mm×80 mm, and were melt-molded at 100° C. while compressing the beads to a height of 60 mm (a level of 85% of the initial volume), followed by drying, thus producing an expanded plastic foam material having a size of 220 mm×220 mm×60 mm.

### Mode for Invention

Hereinafter, a method for producing the expanded plastic foam material according to the present invention will be described in detail with reference to examples and test examples. It is to be understood, however, that these examples are illustrative only and the scope of the present invention is not limited thereto.

### Example 1

Production 1 of Expanded Plastic Foam Material

Expanded polystyrene beads (CL 2500F; SH Chemical Co., Ltd, Korea) were expanded for the first time by adding water vapor thereto, and water was evaporated from the surface of the expanded beads. Then, the expanded beads were aged for 4 hours, such that foaming gas contained in the particles was substituted with air, and thus the particles were provided with restoring force. Then, the expanded beads were further expanded by adding water vapor thereto, thus preparing expanded beads.

50 Be′ sodium silicate was treated with 10 wt %, based on the weight of the sodium silicate, of magnesium hydroxide as an alkaline earth metal compound. The treated material was sufficiently stirred, and then uniformly applied on the surface of the above-prepared expanded beads.

The applied expanded beads were charged into a mold having a size of 220 mm×220 mm×80 mm, and were melt-molded at 100° C. while compressing the beads to a height of 60 mm (a level of 85% of the initial volume), followed by drying, thus producing an expanded plastic foam material having a size of 220 mm×220 mm×60 mm.

### Example 2

### Production 2 of Expanded Plastic Foam Material

An expanded plastic foam material having a size of 220 mm×220 mm×60 mm was produced in the same manner as in Example 1, except that 10 wt % of cement containing an alkaline earth metal compound was used instead of 10 wt % of magnesium hydroxide.

### Example 3

Production 3 of Expanded Plastic Foam Material

An expanded plastic foam material having a size of 220 mm×220 mm×60 mm was produced in the same manner as in Example 1, except that 0.5 wt % of carbonic acid was used instead of 10 wt % of magnesium hydroxide.

### Example 4

Production 4 of Expanded Plastic Foam Material

An expanded plastic foam material having a size of 220 mm×220 mm×60 mm was produced in the same manner as in Example 1, except that cement containing an alkaline earth metal compound was additionally used in an amount of 5 wt % based on the weight of sodium silicate.

### Example 5

Production 5 of Expanded Plastic Foam Material

An expanded plastic foam material having a size of 220 mm×220 mm×60 mm was produced in the same manner as in Example 1, except that carbonic acid was additionally used in an amount of 0.5 wt % based on the weight of sodium silicate.

### Example 6

Production 6 of Expanded Plastic Foam Material

An expanded plastic foam material having a size of 220 mm×220 mm×60 mm was produced in the same manner as in Example 2, except that carbonic acid was additionally used in an amount of 0.5 wt % based on the weight of sodium silicate.

### Example 7

Production 7 of Expanded Plastic Foam Material

An expanded plastic foam material having a size of 220 mm×220 mm×60 mm was produced in the same manner as in Example 1, except that cement and carbonic acid were additionally used in amounts of 5 wt % and 0.5 wt %, respectively, based on the weight of sodium silicate.

### Example 8

Production 8 of Expanded Plastic Foam Material

An expanded plastic foam material having a size of 220 mm×220 mm×60 mm was produced in the same manner as in Example 1, except that potassium silicate was used instead of sodium silicate.

### Example 9

### Production 9 of Expanded Plastic Foam Material

An expanded plastic foam material having a size of 220 mm×220 mm×60 mm was produced in the same manner as in Example 1, except that ethyl alcohol was additionally used in an amount of 1.5 wt % based on the weight of sodium silicate.

### Example 10

### Production 10 of Expanded Plastic Foam Material

An expanded plastic foam material having a size of 220 mm×220 mm×60 mm was produced in the same manner as in Example 1, except that ether was additionally used in an amount of 1.5 wt % based on the weight of sodium silicate.

### Example 11

Production 11 of Expanded Plastic Foam Material

An expanded plastic foam material having a size of 220 mm×220 mm×60 mm was produced in the same manner as in Example 1, except that ketone was additionally used in an amount of 1.5 wt % based on the weight of sodium silicate.

### Example 12

### Production 12 of Expanded Plastic Foam Material

An expanded plastic foam material having a size of 220 mm×220 mm×60 mm was produced in the same manner as in Example 1, except that bentonite and carbon black were additionally used in amounts of 10 wt % and 3 wt %, respectively, based on the weight of sodium silicate.

### Example 13

Production 13 of Expanded Plastic Foam Material

An expanded plastic foam material having a size of 220 mm×220 mm×60 mm was produced in the same manner as in Example 1, except that 10 wt %, based on the weight of sodium silicate, of bentonite, 3 wt % of carbon black, 3 wt % of swollen perlite and 0.1 wt % of a silicon-based water repellant were additionally used.

### Example 14

### Production 14 of Expanded Plastic Foam Material

An expanded plastic foam material having a size of 220 mm×220 mm×60 mm was produced in the same manner as in Example 1, except that 10 wt %, based on the weight of sodium silicate, of bentonite, 3 wt % of swollen perlite and 0.15 wt % of citric acid were additionally used.

### Comparative Example 1

Comparative Production 1 of Expanded Plastic Foam Material

Expanded polystyrene pellets (CL 2500F; SH Chemical Co., Ltd.) were expanded by adding water vapor thereto, thus preparing expanded beads. The expanded beads were aged for 4 hours and were charged into a mold having a size of 220 mm×220 mm to a dry density of 30 kg/cm³. Then, the beads in the mold were molded by adding water vapor thereto, followed by drying, thus producing an expanded plastic material having a size of 220 mm×220 mm×60 mm.

### Comparative Example 2

Comparative Production 2 of Expanded Plastic Foam Material

Expanded polystyrene beads (CL 2500F, SH Chemical Co., Ltd., Korea) were expanded for the first time by adding water vapor thereto, and aged for 4 hours, such that foaming gas contained in the expanded beads was substituted with air, and thus the particles were provided with restoring force. Then, the aged beads were further expanded by adding water vapor thereto, thus preparing expanded beads.

50 Be′ sodium silicate was applied uniformly on the surface of the prepared expanded beads.

The applied expanded beads were charged into a mold having a size of 220 mm×220 mm×80 mm and were melt-molded at 100° C., followed by drying, thus a low-density foam material.

### Test Example 1

Measurement Test of Flame Retardancy and Thermal Resistance

The samples produced in Examples 1-14 and Comparative Examples were left to stand in a well ventilated room for 48 hours and dried at 40±5° C. for 12 hours. Then, the flame retardant performance and thermal resistance of the samples were measured and the bending strength and water resistance thereof were also measured in order to examine the melting point and adhesion thereof.

The flame retardant performance of the samples was assessed in accordance with KS F 2271, and the assessment results are shown in Table 1 below.

The thermal resistance of the sample was measured through differential thermal analysis (DTA) allowing melting and decomposition to be determined by measuring an endothermic or exothermic state and a change in weight according to a change in temperature, and through thermogravimetry (TG). Also, to examine thermal resistance, a change in the shape of each sample was measured in an electric furnace at temperatures of 300° C. and 750° C., and the measurement results are shown in Table 2 below.

Also, to examine adhesion, the bending strength of each sample was assessed in accordance with KS M 3808 (expanded polystyrene insulation material) test methods, and the assessment results are shown in Table 3 below. Moreover, the water resistance of each sample was assessed by immersing each sample in clear water for 24 hours, standing each sample in the room for 48 hours, drying each sample at 40±5° C. for 120 hours, and then evaluating the flame retardant performance of each sample in accordance with KS F 2271, and the assessment results are shown in Table 1 below in combination in order to examine the change after immersion.

TABLE 1
Results of flame retardant performance test after production and flame
retardant performance test after immersion in accordance with KS F 2271

| | Flame-retardant surface test after production | | | | Flame-retardant surface test after immersion | | | |
|---|---|---|---|---|---|---|---|---|
| | Crack | After-flame | Smoke | Temperature- | Crack | After-flame | Smoke | Temperature- |
| Items | (mm) | time (sec)) | coefficient (C_{A}) | time area | (mm) | time (sec) | coefficient (C_{A}) | time area |
| Example 1 | None | 0 | 11.8 | 62.4 | None | 23.7 | 32.9 | 87.7 |
| Example 2 | None | 0 | 8.5 | 53.6 | None | 10.4 | 23.8 | 62.0 |
| Example 3 | None | 0 | 21.4 | 63.9 | None | 8.2 | 22.0 | 71.7 |
| Example 4 | None | 0 | 8.1 | 46.6 | None | 3.2 | 9.9 | 51.1 |
| Example 5 | None | 0 | 8.2 | 51.8 | None | 0.9 | 9.3 | 55.8 |
| Example 6 | None | 0 | 7.7 | 46.4 | None | 0 | 8.4 | 50.1 |
| Example 7 | None | 0 | 7.4 | 45.7 | None | 0 | 8.1 | 48.2 |
| Example 8 | None | 0 | 10.4 | 60.8 | None | 21.3 | 32.0 | 75.9 |
| Example 9 | None | 0 | 18.7 | 61.1 | None | 5.1 | 19.8 | 66.5 |
| Example 10 | None | 0 | 19.5 | 61.9 | None | 5.5 | 20.9 | 67.2 |
| Example 11 | None | 0 | 18.2 | 60.9 | None | 4.5 | 19.7 | 66.1 |
| Example 12 | None | 0 | 7.2 | 41.3 | None | 16.8 | 29.7 | 55.2 |
| Example 13 | None | 0 | 6.2 | 30.7 | None | 15.7 | 28.1 | 43.4 |
| Example 14 | None | 0 | 6.7 | 32.5 | None | 16.4 | 28.4 | 45.8 |

| Comparative | Test was impossible, because it was burned and oxidized by flame in initial state of test | | | | |
|---|---|---|---|---|---|
| Example 1 | | | | | |
| Comparative | None | 0 | 12.3 | 130.0 | Measurement was impossible due to brittleness after immersion |
| Example 2 | | | | | |

In the results of Table 1 above, Comparative Example 1 could not be tested, because it was completely burned to become a small amount of ash in the initial stage of the test, and Comparative Example 2 showed relatively good results in the flame-retardant surface test, but it could not be tested after 24-hr immersion, because the shape thereof was collapsed due to the dissolution of a large portion of silicate.

From the results of Table 1, it could be seen that the expanded plastic foam materials according to Examples 1-14 maintained some of flame-retardant performance even after immersion, and thus the water resistance thereof was significantly excellent compared to that of Comparative Examples.

TABLE 2
Results of thermal performance test
according to TG/DSC measurement

| | Reduction | | |
|---|---|---|---|
| | (%) in | Change in shape after | Change in shape after |
| Items | weight | heating at 300° C. | heating at 750° C. |
| Example 1 | 20.96 | None | None |
| Example 2 | 20.58 | None | None |
| Example 3 | 25.19 | None | None |
| Example 4 | 19.99 | None | None |
| Example 5 | 24.13 | None | None |
| Example 6 | 22.58 | None | None |
| Example 7 | 19.81 | None | None |
| Example 8 | 23.56 | None | None |
| Example 9 | 22.33 | None | None |
| Example 10 | 21.93 | None | None |
| Example 11 | 22.51 | None | None |
| Example 12 | 19.44 | None | None |
| Example 13 | 15.91 | None | None |
| Example 14 | 16.39 | None | None |
| Comparative | 96.72 | Burned to become ash | Test was impossible |
| Example 1 | | | |
| Comparative | 21.67 | Shape was collapsed | Shape was broken to |
| Example 2 | | due to swelling | pieces, and thus |
| | | | completely collapsed |

In the results of Table 2 above, Comparative Example 1 was completely burned, so that only 3.38% of the original weight thereof (100-96.72=3.28) remained and 96.76% of the weight thereof was degraded. Also, in the test for the change in shape by heating at 300° C., it was completely burned to become ash.

The remaining weight of Comparative Example 2 was 78.33% of the original weight thereof (100−21.67=78.33), which was similar to that of Examples, but in the test for the change in shape by heating at 300° C., the shape thereof started to be collapsed due to the swelling of silicate, and in the test for the change in shape by heating at 750° C., it was broken to pieces, and thus completely collapsed.

Thus, from the results of Table 2 above, it could be seen that the expanded plastic foam materials according to Examples 1-14 showed a relatively small weight reduction and maintained their shape without change in the shape-change tests by heating at 300° C. and 750° C., and thus the thermal resistance thereof was significantly excellent compared to that of Comparative Examples.

TABLE 3
Results of density and bending strength
measurement in accordance with KS F 2271

| | | | Specific strength |
|---|---|---|---|
| | Density | Bending strength | (bending strength/ |
| Items | (kg/mm³ m³) | (N/cm²) | density) |
| Example 1 | 42.4 | 30.2 | 0.71 |
| Example 2 | 41.8 | 31.9 | 0.76 |
| Example 3 | 36.9 | 31.6 | 0.86 |
| Example 4 | 45.4 | 33.9 | 0.75 |
| Example 5 | 42.7 | 33.7 | 0.79 |
| Example 6 | 42.8 | 34.9 | 0.82 |
| Example 7 | 45.3 | 35.2 | 0.77 |
| Example 8 | 42.3 | 30.8 | 0.73 |
| Example 9 | 43.3 | 32.3 | 0.75 |
| Example 10 | 43.2 | 32.1 | 0.74 |
| Example 11 | 43.2 | 32.5 | 0.75 |
| Example 12 | 49.8 | 31.4 | 0.63 |
| Example 13 | 50.6 | 33.7 | 0.67 |
| Example 14 | 50.1 | 33.2 | 0.66 |
| Comparative | 24.1 | 21.1 | 0.88 |
| Example 1 | | | |
| Comparative | 36.4 | 19.1 | 0.53 |
| Example 2 | | | |

In the results of Table 3 above, Comparative Example 1 showed high bending strength and specific strength due to the thermal bonding of the expanded plastic itself, but in Examples 1-14 and Comparative Example 2, which had strength realized by thermal bonds smaller than Comparative Example 1 and silicate adhesion, the bending strength and specific strength of Examples were about 50% higher than those of Comparative Example 2.

Thus, from the results of Table 3 above, it could be seen that the expanded plastic foam materials according to Examples 1-14 had significantly excellent adhesion compared to that of Comparative Examples.

Simple modifications or alterations of the inventive expanded plastic foam having excellent water resistance and thermal resistance can be easily performed by one skilled in the art, and thus such modifications or alterations should all be considered to be within the scope of the present invention.

### INDUSTRIAL APPLICABILITY

As described above, the present invention provides the expanded organic plastic foam material having excellent thermal resistance and durability. The inventive expanded plastic foam material formed to have a fire-resistant barrier can be used as the core material of a fire-resistant structure, because the fire-resistant barrier blocks flames upon a fire. Also, it has excellent water resistance, flexibility and adhesion properties, and thus can be advantageously used in practice.

Moreover, the expanded organic plastic foam material according to the present invention has markedly improved sound-absorbing performance due to this barrier, and has the increased interfacial adhesion to other materials, because the surface thereof is modified. Thus, it can be used in various applications, including bonding with sheets, coating with spray coating materials.

1. An expanded organic plastic foam material having excellent thermal resistance and durability, which is produced by preparing plastic beads or plastic foams, modifying silicate with at least one selected from among an alkaline earth metal compound, an alkaline earth metal compound-containing material, and an acid, coating the modified silicate on the prepared plastic beads or plastic foams, melt-molding the coated plastic beads or plastic foams while applying heat and pressure thereto, and drying the molded material.

2. The expanded organic plastic foam material of claim 1, wherein the silicate is at least one selected from the group consisting of sodium silicate, potassium silicate and lithium silicate.

3. The expanded organic plastic foam material of claim 1, wherein the alkaline earth metal compound is represented by MmXn, wherein M is an alkaline earth metal selected from among Be, Mg, Ca and Ba, X is one selected from among Cl, OH, SO₄ and O, and each of m and n are integers.

4. The expanded organic plastic foam material of claim 1, wherein the alkaline earth metal compound-containing material is at least one selected from cement, blast furnace cement, magnesia cement, gypsum, lime, and blast furnace slag.

5. The expanded organic plastic foam material of claim 1, wherein at least one selected from among alcohol, ether, ketone and ester compounds is added to the silicate.

6. The expanded organic plastic foam material of claim 1, wherein at least one selected from among an adhesive aid, a thermal resistance improver, a delaying agent and a water repellant is added to the silicate.

7. The expanded organic plastic foam material of claim 6, wherein the adhesive aid is at least one selected from among a surfactant, a silane coupling agent, polyvinyl alcohol, an ethylene vinyl acetate copolymer, a cellulose adhesive, carbon black, graphite, montmorillonite, bentonite, illite and clay.

8. The expanded organic plastic foam material of claim 6, wherein the thermal resistance improver is at least one selected from among antimony compounds, aluminum oxide, aluminum hydroxide, borax, phosphate, phosphorus-based flame retardants, halogen-based flame retardants, thermosetting resin, dolomite, calcium carbonate, silica powder, titanium oxide, iron oxide, ettringite compounds, perlite, and fly ash.

9. The expanded organic plastic foam material of claim 6, wherein the water repellant is at least one selected from among silicon-based, fluorine-based and paraffin-based water repellents.

10. The expanded organic plastic foam material of claim 6, wherein the delaying agent is at least one selected from among oxycarbon, fluorosilicate, borate, gluconic acid, saccharide, and citric acid.
